(19) United States
(12) Patent Application Publication
(10) Pub. No.: US 2018/0264957 A1
(43) Pub. Date: Sep. 20, 2018

(54) ELECTRIC CABLE COMPRISING A FLUID CONDUIT FOR COOLING

(71) Applicant: Phoenix Contact E-Mobility GmbH, Schieder-Schwalenberg (DE)

(72) Inventors: Thomas Fuehrer, Blomberg (DE); Robert Babezki, Steinheim (DE)

(21) Appl. No.: 15/763,122

(22) PCT Filed: Oct. 13, 2016
(86) PCT No.: PCT/EP2016/074532

§ 371 Date: Mar. 26, 2018

(30) Foreign Application Priority Data
Oct. 15, 2015 (DE) 10 2015 117 508.8

(51) Int. Cl. B60L 11/18; H01B 7/42; H01B 7/282

(52) U.S. Cl. CPC B60L 11/1816; B60L 11/1824; H01R 13/5205; H01B 7/282; B60L 2230/12; H01B 7/425

(57) ABSTRACT

A cable for transmitting an electric current includes: a cable conduit which encloses an inner conduit space; at least one conducting wire extending in the inner conduit space for conducting an electric current; and a fluid line extending in the inner conduit space for guiding a fluid for cooling the cable, the fluid line including at least one discharge opening, which opens into the inner conduit space, for conveying the fluid into the inner conduit space.

### CROSS-REFERENCE TO PRIOR APPLICATIONS

This application is a U.S. National Phase application under 35 U.S.C. § 371 of International Application No. PCT/EP2016/074532, filed on Oct. 13, 2016, and claims benefit to German Patent Application No. DE 10 2015 117 508.8, filed on Oct. 15, 2015. The International Application was published in German on Apr. 20, 2017 as WO 2017/064157 under PCT Article 21(2).

### FIELD

The invention relates to a cable for transmitting an electric current.

### BACKGROUND

A cable of this kind comprises a cable conduit, which encloses an inner conduit space, at least one conducting wire that extends in the inner conduit space for conducting an electric current, and a fluid line that extends in the inner conduit space for guiding a fluid for cooling the cable.

A cable of this kind can be used in particular for charging an electrically operated vehicle (also referred to as an electric vehicle). In this case, the cable may for example be connected to a charging station and also bear a plug-in connector part in the form of a charging plug, which can be inserted into an associated mating connector part in the form of a charging socket on a vehicle in order to thus produce an electrical connection between the charging station and the vehicle.

Charging currents may in principle be transmitted as direct currents or as alternating currents, in particular charging currents in the form of direct currents having a large amperage, for example of greater than 100 A or even greater than 200 A, and being capable of leading to heating of the cable and of a plug-in connector part connected to the cable. This may make it necessary to cool the cable.

A charging cable known from DE 10 2010 007 975 B4 comprises a cooling line which comprises a supply line and a return line for a coolant and thus makes possible a flow of coolant back and forth in the charging cable. The cooling line from DE 10 2010 007 975 B4 is in this case used to remove waste heat generated in an energy store of a vehicle, and also to cool the cable itself

Existing solutions consisting of charging cables having an integrated cooling line may have the disadvantage that removing heat in a load line, in particular in the case of large charging currents, is possible only to a limited extent. As a result, in spite of the cooling line, a (notable) heating of the cable may occur.

A solution for counteracting heating of this kind in the cable could consist in further increasing the cross section of the load line in the cable. However, this has the disadvantage that the cable as a whole is heavier and less flexible, which may impair the handleability of the cable for a user.

### SUMMARY

In an embodiment, the present invention provides a cable for transmitting an electric current, comprising: a cable conduit which encloses an inner conduit space; at least one conducting wire extending in the inner conduit space and configured to conduct an electric current; and a fluid line extending in the inner conduit space and configured to guide a fluid for cooling the cable, the fluid line comprising at least one discharge opening, which opens into the inner conduit space, configured to convey the fluid into the inner conduit space.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a view of a charging station comprising a cable arranged thereon,

FIG. 2 is a view of a plug-in connector part of the cable;

FIG. 3 is a partially cut-free view of a cable conduit, comprising conducting wires and a fluid line laid in the cable conduit;

FIG. 4 is the view according to FIG. 3, without the cable conduit;

FIG. 5 is a schematic view of the cable conduit comprising a spacer arranged therein;

FIG. 6 is a separate view of a spacer;

FIG. 7 is another view of the spacer;

FIG. 8A is a front view of the spacer;

FIG. 8B is the view according to FIG. 8A, with conducting wires and a fluid line arranged on the spacer, enclosed in the cable conduit;

FIG. 9 is a longitudinal sectional view along the cable;

FIG. 10 is an exploded view of a fastening element for fastening the cable conduit to a wall of the charging station;

FIG. 11 is a side view of the fastening element on the charging station; and

FIG. 12 is a longitudinal sectional view through the fastening element.

### DETAILED DESCRIPTION

Accordingly, in an embodiment, the cable for transmitting an electric current includes a fluid line that comprises at least one discharge opening, which opens into the inner conduit space, for conveying the fluid into the inner conduit space.

The fluid line is designed to convey a cooling fluid into the inner conduit space of the cable conduit. The fluid is supplied via the fluid line and exits the fluid line via the discharge opening and enters the inner conduit space, such that the fluid can flow around the conducting wires guided in the cable conduit and absorb heat from the conducting wires.

The conducting wires and the fluid line are enclosed together in the inner conduit space of the cable conduit. The cable conduit surrounds the conducting wires and the fluid line so as to leave a clearance, such that the fluid can exit the fluid line and enter the inner conduit space in order to flow around the conducting wires guided in the inner conduit space. Heat in the conducting wires is thus primarily absorbed by means of the fluid flowing around the conducting wires in the inner conduit space, but only to a lesser extent when the fluid is supplied via the fluid line. The fluid line is thus primarily used to supply the fluid, and not to remove heat. Heat is primarily removed by the fluid flowing inside the inner conduit space of the cable conduit (but outside the fluid line).

A cooling concept of this kind may in principle allow for liquid or gaseous coolant. For example, air may be used as the coolant, and is supplied via the fluid line and enters the inner conduit space of the cable conduit via the discharge opening so as to flow around the conducting wires in the inner conduit space.

It is also conceivable and possible to use a liquid coolant, for example water, which flows around the conducting wires in the cable conduit.

The fluid line is tubular, and extends inside the inner conduit space of the cable conduit. The discharge opening is, in this case, for example, arranged at one end of the fluid line inside the cable conduit such that the fluid guided in the fluid line exits at the end of the fluid line and enters the inner conduit space of the cable conduit.

In this connection, however, it is also conceivable and possible to provide a plurality of mutually spaced discharge openings on the fluid line. For example, a plurality of discharge openings may be provided along the length of the fluid line inside the inner conduit space, such that the fluid exits the fluid line at several points and enters the inner conduit space of the cable conduit.

In one embodiment, the fluid line extends from a first end of the cable conduit to a second end of the cable conduit inside the inner conduit space. The fluid line may in this case extend at least approximately over the entire length of the cable conduit, the fluid line extending into the inner conduit space of the cable conduit at the first end and the discharge opening being arranged for example in the region of the second end of the cable conduit. A cooling fluid can therefore be guided via the fluid line to the second end of the cable conduit so as to exit the fluid line in the region of said second end and enter the inner conduit space of the cable conduit and flow along back along the cable conduit towards the first end. In this way, the fluid flows around the conducting wires laid in the cable conduit and can absorb heat from the conducting wires in order to counteract (excessive) heating of the cable.

At the second end, the cable conduit may for example be connected to a plug-in connector part which can be brought into plugged engagement with an associated mating connector part and comprises a plug-in portion for this purpose, which can be pluggingly connected to the mating connector part. A plug-in connector part of this kind may, when using the cable as a charging cable, be designed for example as a charging plug, which can be brought into plugged engagement with an associated charging socket on an electric vehicle, for example.

At the first end, however, the cable conduit may be connected to a charging station, it being conceivable and possible in principle to rigidly connect the cable conduit to the charging station or to releasably connect said cable conduit to the charging station via a suitable plug-in connection means.

While the one or more conducting wires extend inside the cable conduit up to the plug-in connector part and are electrically connected for example to a contact assembly of the plug-in connector part in order to allow electrical contacting via the plug-in connector part, the fluid is intended to be conveyed inside the cable conduit but not enter into the plug-in connector part. For this purpose, in one embodiment, a sealing element, for example a sealing plate or the like, which seals the inner conduit space against egress of fluid at the second end, may be provided on the second end of the cable conduit. The cable conduit is thus closed off in a fluid-tight manner with respect to the plug-in connector part, it being possible to provide one or more openings in the sealing element through which the one or more conducting wires extend. The fluid exiting the discharge opening of the fluid line is thus diverted at the second end of the cable conduit and flows from the second end towards the first end of the cable conduit along the conducting wires laid in the cable conduit, such that heat can be efficiently absorbed from the conducting wires.

If a liquid, for example water, is used as the cooling fluid, a closed fluid circuit is preferably provided. In this case, the liquid flows for example to the first end of the cable conduit and enters a suitable line at the first end of the cable conduit for conveying the fluid to a pump, for example, and feeding said fluid back into the fluid line.

However, if a gas, for example air, is used as the cooling fluid, an open circuit for guiding the fluid can be provided. The fluid can thus enter the inner conduit space from the fluid line and flows inside the inner conduit space along the cable conduit to the first end of the cable conduit so as to exit the cable conduit at the first end. For this purpose, an outlet opening may be provided in the region of the first end of the cable conduit, which outlet opening is designed to let the fluid exit the inner conduit space such that the fluid can flow out of the cable conduit. The outlet opening may in this case open the cable conduit outwards, i.e. towards an outer region outside the cable conduit, such that the gaseous fluid, e.g. air, can flow out of the cable conduit and, in particular not in the manner of a closed circuit, is in turn fed back into the fluid line.

In order to prevent moisture at the outlet opening from being able to enter the inner conduit space of the cable conduit, the outlet opening is preferably closed by means of a sealing element. Said sealing element is in this case designed such that fluid can exit the cable conduit but moisture from the outside cannot enter the inner conduit space of the cable conduit. For example, the sealing element may be produced from a resilient material, for example a rubber or plastics material, and form a membrane which for example comprises a slot opening as the outlet for the fluid.

The cable conduit may in particular be arrangeable on a charging station, in particular a housing wall of the charging station. For this purpose, a fastening element is provided on the first end of the cable conduit associated with the charging station, by means of which fastening element the cable conduit can be connected to the charging station.

In order to prevent transfer of the fluid into the charging station, in this case, in one embodiment, a sealing plug may be provided on the fastening element, which sealing plug closes the cable conduit at the first end thereof in a fluid-tight manner.

In this case, in order to introduce the one or more conducting wires and the fluid line from the charging station into the inner conduit space of the cable conduit, the sealing plug preferably comprises an opening for each conducting wire and line, through which opening the conducting wires and the fluid line are guided. The conducting wires and the fluid line thus extend from the charging station into the cable conduit, the transition between the charging station and the cable conduit being sealed by means of the sealing plug, and therefore fluid cannot flow from the cable conduit past the conducting wires and the fluid line into the charging station.

The conducting wires are preferably laid as separate individual lines in the cable conduit. In particular, the conducting wires are not enveloped in a cable sheath together, but rather are laid in the cable conduit individually and separately. This makes it possible for the fluid to be able to flow directly around the conducting wires and thus to be able to absorb heat directly from the conducting wires.

In one embodiment, the internal diameter of the cable conduit is more than twice as large as the internal diameter of the fluid line. The clearance of the fluid line, inside which the fluid is supplied, is thus significantly smaller than the clearance of the cable conduit, which results in the flow cross section for the fluid in the fluid line being significantly smaller than the flow cross section for the fluid in the inner conduit space outside the fluid line. This causes the fluid to be supplied at a relatively high flow speed via the fluid line, but then flows at a reduced flow speed outside the fluid line in the inner conduit space. The fluid thus flows around the conducting wires at a relatively low flow speed, such that the fluid, for example air, can absorb heat from the conducting wires in a favorable manner.

The fluid line and the cable conduit may for example have a circular cross section in a non-bent or kinked basic shape. The flow cross section of the fluid line and the flow cross section of the cable conduit are thus proportional to the square of the diameter.

The cable conduit is preferably flexible, along with the conducting wires laid therein and the fluid line, such that the cable can be laid in a flexible manner to an electric vehicle and thus be easily handled by a user. When laying the cable, in order to ensure that the fluid line and the conducting wires extending in the inner conduit space of the cable conduit are laid in an orderly manner with respect to one another, one or more spacers are arranged in the inner conduit space of the cable conduit, to which spacers the conducting wires and the fluid line are secured. A plurality of spacers are preferably offset relative to one another along the length of the cable conduit, preferably arranged so as to be equally spaced, and hold the conducting wires and the fluid line in a defined position relative to one another. Orderly laying of the conducting wires and the fluid line inside the cable conduit can be achieved by means of the spacers, such that the formation of heat pockets on account of conducting wires lying one on top of the other can be prevented.

According to another aspect, a charging station comprises a cable of the previously described type.

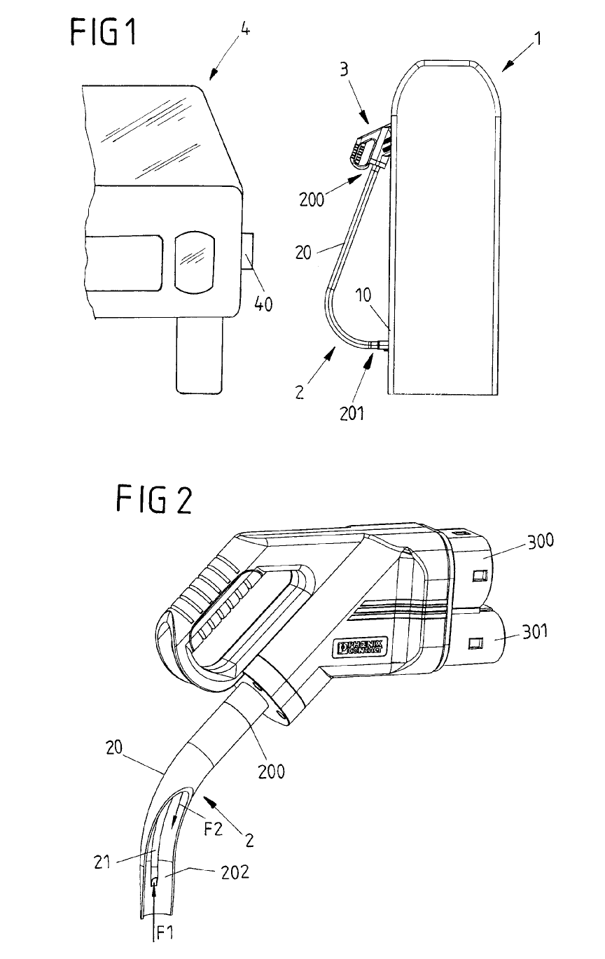

FIG. 1 shows a charging station 1 which is used to charge an electrically operated vehicle 4, also referred to as an electric vehicle. The charging station 1 is designed to supply a charging current in the form of an alternating current or a direct current and comprises a cable 2 which is connected at one end 201 to the charging station 1 and at the other end 200 to a plug-in connector part 3 in the form of a charging plug.

As can be seen in the enlarged view according to FIG. 2, the plug-in connector part 3 comprises plug-in portions 300, 301 on a housing 30, by means of which plug-in portions the plug-in connector part 3 can be brought into plugged engagement with an associated mating connector part 40 in the form of a charging socket on the vehicle 4. In this way, the charging station 1 can be electrically connected to the vehicle 4 in order to transmit charging currents from the charging station 1 to the vehicle 4.

In order to make possible rapid charging of the electric vehicle 4, the transmitted charging currents have a large amperage, e.g. greater than 100 A, perhaps even in the order of 200 A or above. Because of such high charging currents, thermal losses result in the conducting wires of the cable 2, which may lead to heating of the cable 2. In the case of amperages used today in a charging station 1, thermal losses in the range of 50 W per meter of the cable 2 or more may for example occur, which may be accompanied by significant heating of the cable 2.

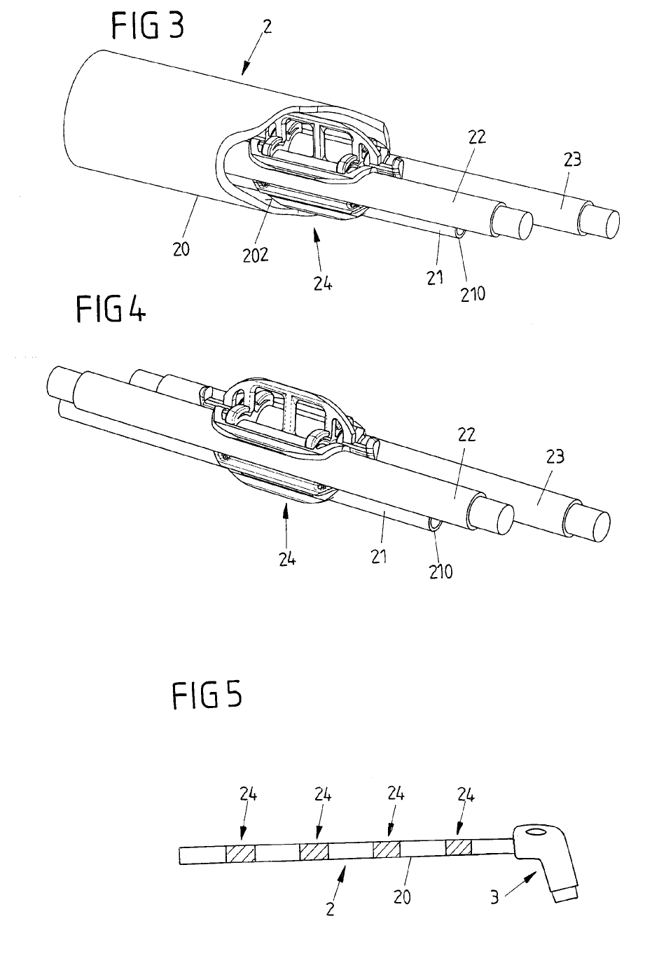

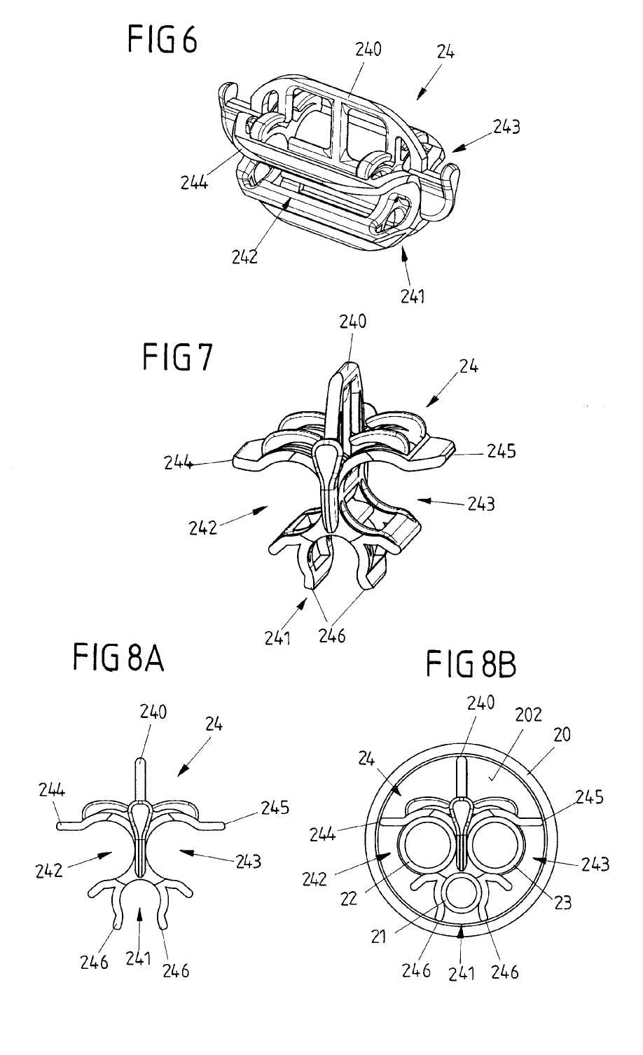

In order to remove heat generated in the cable 2, a fluid line 21 is provided in the embodiment of a cable 2 shown in FIGS. 2 to 9, which fluid line is used to supply a fluid for cooling conducting wires 22, 23 of the cable 2. By means of the fluid, which can be a liquid or a gas, heat generated in the conducting wires 22, 23 is absorbed and transported away, such that (excessive) heating of the cable 2 is counteracted.

The conducting wires 22, 23 are, like the fluid line 21, enclosed in a cable conduit 20 of the cable 2. The cable conduit 20 extends in this case between the charging station 1 and the plug-in connector part 3 and is connected at a first end 201 to the charging station 1 and at a second end 200 to the plug-in connector part 3. The conducting wires 22, 23 and the fluid line 21 extend longitudinally inside an inner conduit space 202 enclosed by the cable conduit 20 and are guided inside the cable conduit 20 between the charging station 1 and the plug-in connector part 3.

The conducting wires 22, 23 extend from the charging station 1 to the plug-in connector part 3 and into the plug-in connector part 3, so as to electrically contact a contact assembly of the plug-in connector part 3. Charging currents are transmitted between the charging station 1 and the vehicle 4 via the conducting wires 22, 23 during a charging procedure.

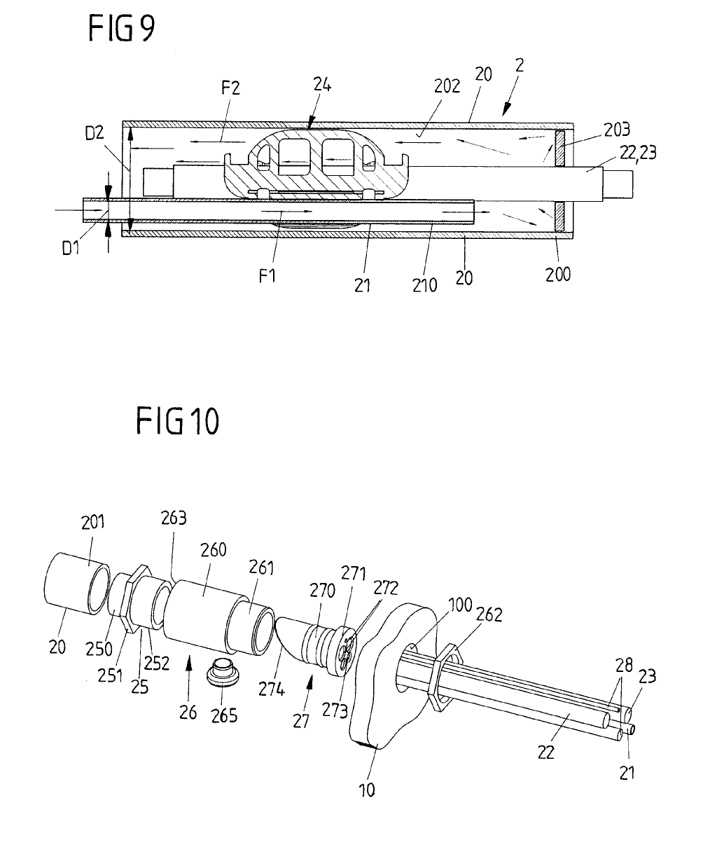

In contrast, the fluid line 21 extends from the charging station 1 into the region of the end 200 of the cable conduit 20 associated with the plug-in connector part 3, but ends before the plug-in connector part 3, as shown in FIG. 9. A fluid is supplied from the sides of the charging station 1 via the fluid line 21 in a flow direction F1 and exits at a discharge opening 210 on one end of the fluid line 21 and enters the inner conduit space 202 of the cable conduit 20. The fluid thus flows via the fluid line 21 in the flow direction F1 into the inner conduit space 202 and then flows inside the inner conduit space 202 from the end 200 of the cable conduit 20 associated with the plug-in connector part 3 back in the flow direction F2 to the end 201 nearer the charging station 1, so as to flow around the conducting wires 22, 23 and absorb heat from the conducting wires 22, 23.

The fluid line 21 has a considerably smaller internal diameter D1 compared with the cable conduit 20. The fluid thus flows in the fluid line 21 at a relatively high flow speed and enters into the inner conduit space 202 via the discharge opening 210 on the end of the fluid line 21. On account of the larger diameter D2 and the corresponding larger flow cross section of the inner conduit space 202 of the cable conduit 20, the fluid then flows in the flow direction F2 at a reduced flow speed inside the inner conduit space 202 (but outside the fluid line 21).

The fluid line 21 and the cable conduit 20 have, in a non-deformed state, an at least approximately circular cross section, but are also flexible, such that the cable 2 can be laid in an easily handleable manner by a user to a vehicle 4 to be charged.

The conducting wires 22, 23 and the fluid line 21 are arranged inside the cable conduit 20 in an orderly manner and, for this purpose, are arranged on a plurality of spacers 24 which, as shown in the schematic view according to FIG. 5, are placed at regular intervals along the cable 2. The spacers 24 are designed as plastics material molded parts and each comprise receiving means 241-243 for receiving the fluid line 21 (in the receiving means 241) and the conducting wires 22, 23 (in the receiving means 242, 243).

The fluid line 21 and the conducting wires 22, 23 can be connected to the spacers 24 in a clipping manner by means of the receiving means 241-243, in order to in this way secure the fluid line 21 and the conducting wires 22, 23 together in a defined manner inside the inner conduit space 202.

As can be seen in the view according to FIG. 8B, the fluid line 21 and the conducting wires 22, 23 are held so as to be spaced apart from one another by means of spacers 24. The spacers 24 rest against the inside of the wall of the cable conduit 20 in each case via contact edges 240, 244-246, such that the fluid line 21 and the conducting wires 22, 23 are held in an orderly manner inside the inner conduit space 202.

By using the spacers 24, it is possible to prevent the conducting wires 22, 23 from lying one on top of the other in a disorderly manner and from twisting during bending of the cable 2, as a result of which heat pockets producing increased heating could arise. The spacers 24 ensure that the conducting wires 22, 23 and the fluid line 21 remain laid in an orderly manner inside the cable conduit 20 when the cable 2 bends.

As can be seen in the sectional view according to FIG. 9, the fluid, supplied via the fluid line 21, flows into the inner conduit space 202 at the discharge opening 210 of the fluid line 21. Because the fluid line 21 extends almost up to the end 200 of the cable conduit 20 associated with the plug-in connector part 3, the fluid is admitted into the inner conduit space 202 in the region of said end 200. In order to prevent the fluid from draining via the plug-in connector part 3, the transition between the cable conduit 20 and the plug-in connector part 3 is sealed by means of a sealing element 203 in the form of a planar sealing element, such that the fluid inside the inner conduit space 202 is diverted before reaching the plug-in connector part 3 and flows inside the cable conduit 20 from the end 200 associated with the plug-in connector part 3 to the end 201 of the cable 2 associated with the charging station 1.

The fluid may in principle be a liquid or a gas.

If a liquid, for example water, is used for cooling, a closed coolant circuit is preferably provided, within which the fluid is drawn away at the end 201 of the cable 2 nearer the charging station 1 via a suitable line and is fed back into the fluid line 21 for example via a coolant pump.

However, if a gas, for example air, is used for cooling, an open coolant circuit can be provided, within which the gas is discharged from the cable conduit 20 at the end 201 of the cable conduit 20 nearer the charging station 1 and is not (directly) fed back into the fluid line 21.

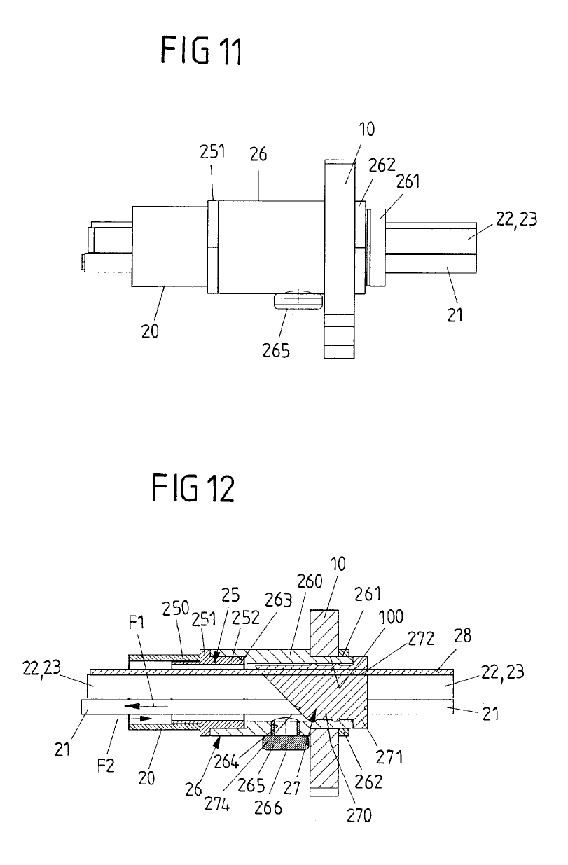

An embodiment of a fastening element for fastening the cable conduit 20 to the charging station 1 for providing an open circuit of this kind is shown in FIGS. 10 to 12. In this embodiment, the end 201 of the cable conduit 20 is attached to an attachment connector 250 of a fastening element 25 which is screwed into a threaded opening 263 in a body 260 of a tube element 26 by means of a threaded portion 252 adjoining a hexagonal collar 251. A threaded portion 261 of the tube element 26 reaches through an opening 100 in a housing wall 10 of the charging station 1 and is secured to the rear side of the housing wall 10 by means of a nut 262.

A sealing plug 27 for sealing the cable conduit 20 is arranged on said end 201 inside the tube element 26. A shaft 270 of the sealing plug 27 is inserted in the tube element 26, and the end face of a collar 271 of said sealing plug rests against the threaded portion 261 of the tube element 26, as shown in the sectional view according to FIG. 11.

A discharge opening 264 is arranged, so as to point vertically downwards, on the body 260 of the tube element 26, via which discharge opening the fluid conveyed in the inner conduit space 202 outside the fluid line 21 can flow out of the cable conduit 20. The discharge opening 264 is sealed by means of a sealing element 265 against ingress of moisture from the outside, and forms a membrane comprising a slot opening 266 through which fluid can flow out of the inner conduit space 202.

As shown in FIG. 11, the sealing plug 27 inside the tube element 26 comprises a bevel 274, by means of which the fluid is conveyed to the discharge opening 264 on the underside of the body 260 of the tube element 26.

Openings 272, 273 are formed in the sealing plug 27 (see FIG. 10), through which the conducting wires 22, 23, 28 and the fluid line 21 are guided. The fluid line 21 is in particular also inserted via the opening 273 into the cable conduit 20 of the cable 2 on the side of the charging station 1, such that a fluid can be conveyed into the fluid line 21 by means of a suitable pump device of the charging station 1.

The conducting wires 22, 23, 28 and the fluid line 21 are laid via the openings 272, 273 in a fluid-tight manner by means of the sealing plug 21, such that the fluid from the inner conduit space 202 cannot flow past the conducting wires 22, 23, 28 and the fluid line 21 through the sealing plug 27.

In the embodiment shown, the cable 2 is rigidly connected to the charging station 1. This may be advantageous but is not necessary. In principle, it is also conceivable and possible to connect the cable 2 via a suitable (detachable) plug-in connector part to the charging station 1, suitable flow contact for connecting the fluid line 21 being provided in this case on the plug-in connector part.

The basic concept of the invention is not limited to the embodiments described above, but can in principle also be implemented by quite different embodiments.

Advantageously, conducting wires are laid in a cable of the above-described type separately and so as to be isolated from one another, and in particular are not encased in a (common) cable sheath. The fluid in the inner conduit space can thus flow around the conducting wires individually and thus effectively absorb the heat from the conducting wires.

Because the cable conduit has a larger internal diameter and thus a clearance, inside which cable conduit a fluid can flow around the conducting wires guided in the cable conduit, it is itself used as a return line for the fluid. Therefore, merely one fluid which exits the fluid line and flows along the cable conduit around the conducting wires inside the cable conduit is supplied via the fluid line inside the cable conduit.

In principle it is also conceivable and possible to provide a plurality of discharge openings on the fluid line, such that an fluid can exit the fluid line at several points and enter the inner conduit space of the cable conduit.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 charging station
10 housing wall
100 opening
2 charging cable
20 cable conduit
200, 201 end
202 inner space
203 sealing element
21 fluid line
210 discharge opening
22, 23 conducting wire
24 spacer
240 contact edge
241-243 receiving means
244-246 contact edge
25 fastening element
250 attachment connector
251 collar
252 threaded portion
26 tube element
260 body
261 threaded portion
262 nut
263 threaded opening
264 opening
265 sealing element
266 slot opening
27 sealing plug
270 shaft
271 collar
272 openings
273 opening
274 bevel
28 conducting wires
3 charging plug
30 housing
300, 301 plug-in portion
4 vehicle
40 charging socket
D1, D2 diameter
F1, F2 flow

1. A cable for transmitting an electric current, comprising:
a cable conduit which encloses an inner conduit space;
at least one conducting wire extending in the inner conduit space and electric current; and
a fluid line extending in the inner conduit space and configured to guide a fluid for cooling the cable,
the fluid line comprising at least one discharge opening, which opens into the inner conduit space configured to convey the fluid into the inner conduit space.

2. The cable according to claim 1, wherein the fluid comprises a liquid or a gas.

3. The cable according to claim 1, wherein the at least one discharge opening arranged on one end of the fluid line inside the cable conduit.

4. The cable according to claim 1, wherein the fluid line extends from the first end of the cable conduit up to a second end of the cable conduit inside the inner conduit space.

5. The cable according to claim 4, wherein the fluid line extends into the inner conduit space at the first end of the cable conduit and the at least one discharge opening is arranged in a region of the second end of the cable conduit.

6. The cable according to claim 4, wherein the cable conduit is connected at the second end to a plug-in connector part, which comprises a plug-in portion configured for plugging connection to an associated mating connector part.

7. The cable according to claim 4, wherein the cable conduit comprises a first sealing element on the second end thereof, which first sealing element is configured to seal the inner conduit space against egress of fluid at the second end.

8. The cable according to claim 4, wherein the cable comprises an outlet opening in a region of the first end of the cable conduit that is configured to discharge the fluid from the inner conduit space.

9. The cable according to claim 8, wherein the outlet opening is closed by a second sealing element, which is configured to allow egress to fluid out of the cable conduit but which is configured to seal the outlet opening against ingress of moisture into the cable conduit.

10. The cable according to claim 4, wherein the cable conduit is connected at the first end thereof to a fastening element configured to fasten the cable conduit to a charging station.

11. The cable according to claim 10, wherein the fastening element comprises a scaling plug, which is configured to seal the inner conduit space against egress of fluid at the first end.

12. The cable according to claim 11, wherein the sealing plug comprises at least one first opening configured to guide through the at least one conducting wire and a second opening configured to guide through the fluid line.

13. The cable according to claim 1, further comprising a plurality of conducting wires laid in the cable conduit as separate individual lines.

14. The cable according to claim 1, wherein an internal diameter of the cable conduit is more than twice as large as an internal diameter of the fluid line.

15. The cable according to claim 1, wherein the cable comprises at least one spacer arranged in the inner conduit space, on which spacer the at least one conducting wire and the fluid line are arranged and held in position relative to one another.

16. The cable according to claim 15, wherein the cable comprises a plurality of spacers that are arranged in the inner conduit space and that are offset relative to one another along the cable conduit.

17. A charging station comprising the cable according to claim 1.
